(19) United States
(12) Patent Application Publication
(10) Pub. No.: US 2016/0170106 A1
(43) Pub. Date: Jun. 16, 2016

(54) COLOR TUNING FOR ELECTROPHORETIC DISPLAY DEVICE

(71) Applicant: E INK CALIFORNIA, LLC

(72) Inventors: Ming Wang, Fremont, CA (US); Hui Du, Milpitas, CA (US); Craig Lin, Oakland, CA (US); Bryan Hans Chan, San Francisco, CA (US); HongMei Zang, Fremont, CA (US)

(21) Appl. No.: 15/040,193

(22) Filed: Feb. 10, 2016

Related U.S. Application Data
(63) Continuation-in-part of application No. 14/791,197, filed on Jul. 2, 2015.
Application No. 14/791,197 is a continuation-in-part of application No. 13/973,712, filed on Aug. 22, 2013, now abandoned.
Application No. 13/973,712 is a continuation-in-part of application No. 12/852,411, filed on Aug. 6, 2010, now abandoned.
(60) Provisional application No. 61/234,959, filed on Aug. 18, 2009.

(51) Int. Cl. G02B 5/22; G02F 1/1335; G02F 1/167

(52) U.S. Cl. CPC G02B 5/223; G02F 1/167; G02F 1/133516

(57) ABSTRACT

The present invention is directed to color tuning methods for electrophoretic display devices. For example, a color tuning agent may be added to a composition for forming a display cell structure or a primer layer. Alternatively, a separate color tuning layer may be added to a display device. Further, a color tuning agent may be added to an electrophoretic display fluid. The color tuning methods are useful for adjusting the color temperature of a display device.

This application is a continuation-in-part of U.S. application Ser. No. 14/791,197, filed Jul. 2, 2015; which is a continuation-in-part of U.S. application Ser. No. 13/973,712, filed Aug. 22, 2013; which is a continuation-in-part of U.S. application Ser. No. 12/852,411, filed Aug. 6, 2010, abandoned; which claims priority to U.S. Provisional Application No. 61/234,959 filed Aug. 18, 2009. The contents of the above-identified applications are incorporated herein by reference in their entirety.

### FIELD OF THE INVENTION

The present invention is directed to color tuning methods for electrophoretic display devices.

### BACKGROUND OF THE INVENTION

An electrophoretic display (EPD) is a non-emissive device based on the electrophoresis phenomenon influencing charged pigment particles dispersed in a dielectric solvent. An EPD typically comprises a pair of spaced-apart plate-like electrodes. At least one of the electrode plates, typically on the viewing side, is transparent. An electrophoretic fluid composed of a dielectric solvent with charged pigment particles dispersed therein is enclosed between the two electrode plates.

An electrophoretic fluid may have one type of charged pigment particles dispersed in a solvent of a contrasting color. In this case, when a voltage difference is imposed between the two electrode plates, the pigment particles migrate by attraction to the plate of polarity opposite that of the pigment particles. Thus, the color showing at the transparent plate can be either the color of the solvent or the color of the pigment particles. Reversal of plate polarity will cause the particles to migrate back to the opposite plate, thereby reversing the color.

Alternatively, an electrophoretic fluid may have two types of pigment particles of contrasting colors and carrying opposite charges and the two types of pigment particles are dispersed in a clear solvent. In this case, when a voltage difference is imposed between the two electrode plates, the two types of pigment particles would move to opposite ends. Thus one of the colors of the two types of pigment particles would be seen at the viewing side.

It is also possible to have more than two types charged pigment particles in an electrophoretic fluid, allowing a display device to display multiple color states.

The components in an electrophoretic display device need to be optimized in order to achieve an acceptable level of whiteness (i.e., brightness) and contrast ratio of images displayed. The whiteness and contrast ratio are critical factors that determine the quality of a display device.

However in practice, regardless of the number of types of pigment particles in a fluid, it is inevitable that a small portion of different colored pigment particles would mix to cause tinting issue, especially at the white state, that is, if there are any non-white pigment particles mixed with the white particles, albeit in a small amount, a non-neutral white state will be seen.

### SUMMARY OF THE INVENTION

One aspect of the present invention is directed to a display device which comprises a display cell structure and optionally a primer layer, wherein said display cell structure or the primer layer, if present, is formed from a color tuning composition comprising a color tuning agent.

In one embodiment, the color tuning agent is a leuco dye. In one embodiment, the leuco dye is selected from the group consisting of triarylmethane compounds, bisphenylmethane compounds, xanthene compounds and thiazine compounds. In one embodiment, the leuco dye is crystal violet lactone, malachite green lactone, leuco base fuchsin or p-nitrobenzoyl leuco methylene blue.

In one embodiment, the color tuning composition further comprises a photo oxidative agent or photo acid generator. In one embodiment, the color tuning composition further comprises a dispersant. In one embodiment, the color tuning agent has a concentration of less than 5% by weight, preferably less than 3%, in the color tuning composition.

Another aspect of the present invention is directed to a display device which comprises display cells filled with a display fluid; and a color tuning layer formed from a color tuning composition comprising a color tuning agent and a polymer carrier.

In one embodiment, the color tuning agent is a light absorbing or light emitting material. In one embodiment, the light absorbing material is an organic or inorganic dye or pigment. In one embodiment, the light emitting material is a photoluminescent material. In one embodiment, the photoluminescent material is a fluorescent dye or fluorescent inorganic phosphor. In one embodiment, the color tuning agent is a fluorescent brightening agent.

In one embodiment, the polymer carrier is a thermoplastic material, a thermoset material, or a precursor or derivative thereof.

A further aspect of the present invention is directed to a display device comprising a plurality of display cells wherein the display cells are filled with an electrophoretic fluid comprising charged pigment particles and a color tuning agent in a solvent or solvent mixture.

In one embodiment, the color tuning agent carries a charge polarity same as that carried by the charged pigment particles which are white. In one embodiment, the color tuning agent is selected from the group consisting of CI pigment PB 15, PB15:1, PB15:2, PB15:3, PB15:4 PG36, PG58, PG7, PY138, PY150, PY20 and PY83.

Yet a further aspect of the present invention is directed to a method for adjusting the color temperature of a display device, which method comprises

i) determining color temperature of colors displayed by the display device;

ii) selecting one or more color tuning agent based on the color temperature; and

iii) providing a color tuning composition comprising the color tuning agent(s) selected, to form a display cell structure, a primer layer or a separate color tuning layer or to be used as an electrophoretic fluid.

In one embodiment, the method causes Δa* in the L*,a*,b* color system of a color displayed to be less than 5. In one embodiment, the method causes Δb* in the L*,a*,b* color system of a color displayed to be less than 5. In one embodiment, the method causes an a* value in the L*,a*,b* color system of a white color displayed to be between 0 and minus 1.5. In one embodiment, the method causes a b* value in the L*,a*,b* color system of a white color displayed to be between 0 and minus 2.

### BRIEF DESCRIPTION OF THE DRAWINGS

FIGS. 1a and 1b illustrate a display film.

FIG. 2 illustrates adding a color tuning agent into a composition for forming a display cell structure and a primer layer.

FIG. 3 illustrates adding a color tuning agent into a composition for forming a microcapsule-based display film.

FIG. 4 illustrates adding a separate color tuning layer onto a display film.

FIG. 5 illustrates adding a color tuning agent into an electrophoretic fluid.

FIG. 6 illustrates how a color tuning layer in an electrophoretic display may affect the b* value of a color displayed.

### DETAILED DESCRIPTION OF THE INVENTION

The color tuning methods of the present invention are for adjusting the “color temperature” of a display device. The term “color temperature” which is a term often used in art or photography, is a characteristic of visible light. The color temperature of a light source is determined by comparing its chromaticity with that of an ideal black-body radiator. The temperature, usually measured in kelvins (K), at which the heated black-body radiator matches the color of the light source is that source's color temperature. Higher color temperatures (5000 K or more) are “cool” (green-blue) colors, and lower color temperatures (2700-3000 K) are “warm” (yellow-red) colors.

The term “adjusting color temperature” may be defined by the CIE L*,a*,b* color space system. An L*,a*,b* color space is a color-opponent space with dimension L* for lightness and a* and b* for the color-opponent dimensions, based on nonlinearly compressed CIE XYZ color space coordinates. In the context of the present invention, the term “adjusting color temperature” is defined as the change of the a* value (Δa*) of a color displayed (e.g., white) being less than 5 or the change of the b* value (Δb*) of a color displayed (e.g., white) being less than 5, under the condition of CIE Standard Illuminant D65 (which is commonly used standard illuminant defined by the International Commission on Illumination). D65 is intended to represent average daylight and has a correlated color temperature of approximately 6,500K.

The term “adjusting color temperature” as defined would not include adding a dye, pigment or color filter to alter a color state displayed by a display device because adding a dye, pigment or color filter usually would cause Δa* or Δb* to be more than 5.

The details of the CIE L*,a*,b* color space system are given in “Understanding Color Management” by Abhay Sharma (Delmar Cengage Learning; First Edition, Aug. 11, 2003), the content of which is incorporated herein by reference in its entirety.

According to the present invention, a color tuning agent/layer may absorb the UV spectrum and emits back a visible light (e.g., blue) which has a wavelength longer than that of the UV spectrum.

Many color tuning agents are suitable for the present invention. A few examples are named herein. However the scope of the present invention is not in any way limited by the agents listed. The color tuning agent may also be referred to as a “colorant”.

The color tuning agent, in the context of the present invention, may be a light absorbing or light emitting material. Light absorbing color tuning agents may include, but are not limited to, organic and inorganic dyes and pigments. Light emitting color tuning agents may include, but are not limited to, photoluminescent materials, such as fluorescent dyes and fluorescent inorganic phosphors.

In one embodiment, a fluorescent brightening agent may be used as a color tuning agent. Suitable fluorescent brightening agents may include, but are not limited to, triazine-stilbenes (di-, tetra- or hexa-sulfonated), coumarins, imidazolines, diazoles, triazoles, benzoxazolines and biphenyl-stilbenes.

Examples of commercially available color tuning agents for the purpose of the present invention may include, but are not limited to, Tinopal OB (by Ciba), Eastobrite OB-1 (by Eastman), Eastobrite OB-3 (by Eastman), Hostalux KCB (by Clariant), Hostalux KSN (by Clariant), Uvitex FP (by Ciba), D-298 (by DayGlo), D-286 (by DayGlo), D-282 (by DayGlo) and D-211 (by DayGlo). More are given in sections below.

Since the fluorescent materials have strong absorption in the UV range, a color tuning layer formed from such a material may also help block harmful UV rays to protect the display film.

The color tuning agent usually is either transparent or convertible to a transparent material.

The color tuning agent may also be a conductive or low resistance filler. Examples include, but are not limited to, phthalocyanine pigments and metal oxides. An example of such metal oxide filler is zinc antimonate (Clenax from Nissan chemical) which exhibits a green-blue hue. When such a material is used, the color tuning layer may serve the additional purpose of resistance tuning.

The leuco dyes are particularly useful as a color tuning agent, when radiation is involved. A leuco dye is a dye whose molecules can acquire two forms, one of which is colorless. Certain leuco dye will change to its colored form under irradiation in the presence of an acidic agent or oxidative agent, to adjust the color temperature of colors displayed. The acidic agent and oxidative agent can also be generated by irradiation. Examples of suitable leuco dyes include, but are not limited to, triarylmethane compounds, bisphenylmethane compounds, xanthene compounds and thiazine compounds. More specifically, such leuco dyes include, but are not limited to, crystal violet lactone, malachite green lactone, leuco base fuchsin and p-nitrobenzoyl leuco methylene blue. Suitable photo oxidative agent and photo acid generator include onium salts, such as iodonium salts and sulfonium salts.

Preferably, the color tuning agent is in a sub-micron size when it is in the dispersed state. More preferably, the agent is less than 200 nm when in its dispersed state.

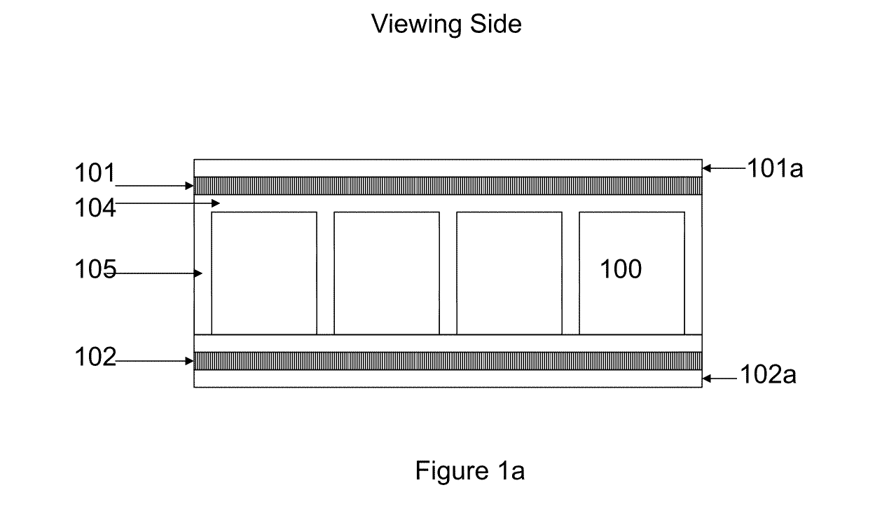

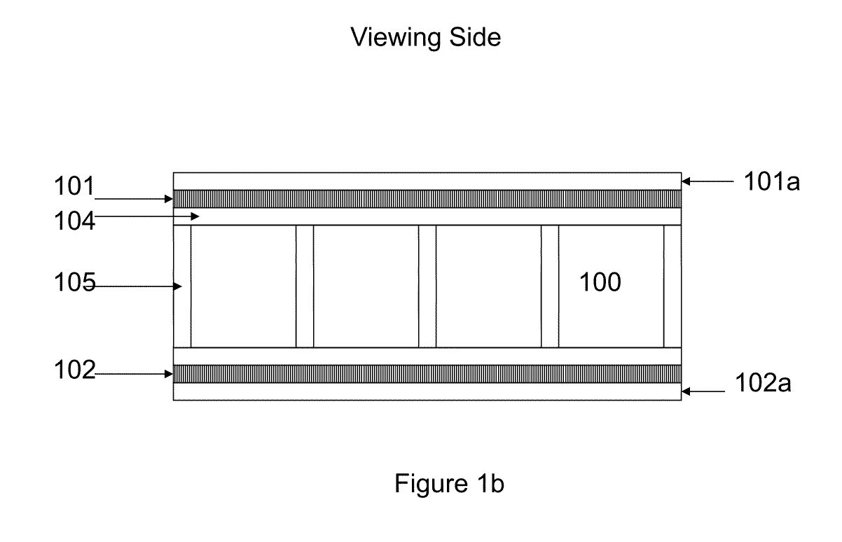

FIGS. 1a and 1b illustrate examples of electrophoretic display structure. As shown, a plurality of the display cells (100) are sandwiched between two electrode layers (101 and 102). Layers 101a and 102a are plastic substrates attached to the electrode layers 101 and 102, respectively.

The display cells are separated by partition walls (105), which form a display cell structure.

In FIG. 1a, the partition walls 105 and the primer layer 104 are in a continuous form. In other words, the display cell structure and the primer layer are formed from the same material in the same process. In FIG. 1 b, the primer layer 104 is a separate layer and the display cells are formed on the primer layer 104.

The structures as shown in FIGS. 1a and 1b may be prepared by the microcup technology as disclosed in U.S. Pat. No. 6,930,818, the content of which is incorporated herein by reference in its entirety. However, in the context of the present invention, the term “display cells” is intended to encompass any micro-containers (e.g., microcups, microcapsules, microchannels or conventional partition type display cells), regardless of their shapes or sizes, as long as they perform the intended functions.

The display cells are filled with an electrophoretic fluid comprising charged pigment particles dispersed in a solvent or solvent mixture.

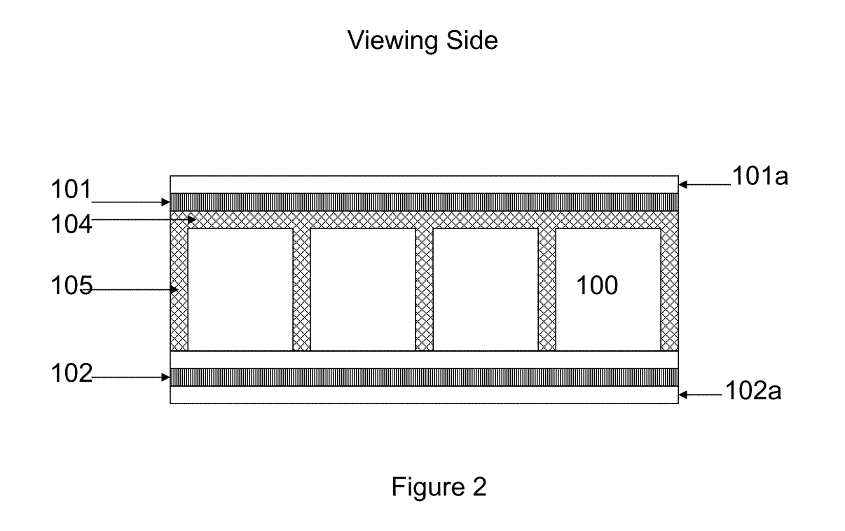

In one aspect of the present invention, a color tuning agent may be added into a composition which forms the display cell structure and/or the primer layer. In other words, the display cell structure and/or the primer layer are the color tuning layer(s), as shown in FIG. 2.

The compositions for forming the display cell structure and/or the primer layer without a color tuning agent were previously disclosed in U.S. Pat. Nos. 6,831,770, 6,930,818 and 7,880,958 and U.S. patent application Ser. No. 13/686,778.

Briefly, U.S. Pat. Nos. 6,831,770 and 6,930,818 describe that a suitable composition for forming microcups, which may comprise a thermoplastic, thermoset, or a precursor thereof. Examples of thermoplastic or thermoset precursor may be multifunctional acrylate or methacrylate, multifunctional vinylether, multifunctional epoxide and oligomers or polymers thereof. A crosslinkable oligomer imparting flexibility, such as urethane acrylate or polyester acrylate, may also be added to improve the flexure resistance of the microcups formed.

U.S. Pat. No. 7,880,958 describes composition for microcups which may comprise a polar oligomeric or polymeric material. Such a polar oligomeric or polymeric material may be selected from the group consisting of oligomers or polymers having at least one of the groups such as nitro (—NO₂), hydroxyl (—OH), carboxyl (—COO), alkoxy (—OR wherein R is an alkyl group), halo (e.g., fluoro, chloro, bromo or iodo), cyano (—CN), sulfonate (—SO₃) and the like. The glass transition temperature of the polar polymer material is preferably below about 100° C. and more preferably below about 60° C. Specific examples of suitable polar oligomeric or polymeric materials may include, but are not limited to, polyhydroxy functionalized polyester acrylates (such as BDE 1025, Bomar Specialties Co, Winsted, Conn.) or alkoxylated acrylates, such as ethoxylated nonyl phenol acrylate (e.g., SR504, Sartomer Company), ethoxylated trimethylolpropane triacrylate (e.g., SR9035, Sartomer Company) or ethoxylated pentaerythritol tetraacrylate (e.g., SR494, from Sartomer Company).

U.S. patent application Ser. No. 13/686,778 discloses another type of composition for forming microcups. The composition comprises (a) at least one difunctional UV curable component, (b) at least one photoinitiator, and (c) at least one mold release agent. Suitable difunctional components may have a molecular weight higher than about 200. Difunctional acrylates are preferred and difunctional acrylates having an urethane or ethoxylated backbone are particularly preferred. More specifically, suitable difunctional components may include, but are not limited to, diethylene glycol diacrylate (e.g., SR230 from Sartomer), triethylene glycol diacrylate (e.g., SR272 from Sartomer), tetraethylene glycol diacrylate (e.g., SR268 from Sartomer), polyethylene glycol diacrylate (e.g., SR295, SR344 or SR610 from Sartomer), polyethylene glycol dimethacrylate (e.g., SR603, SR644, SR252 or SR740 from Sartomer), ethoxylated bisphenol A diacrylate (e.g., CD9038, SR349, SR601 or SR602 from Sartomer), ethoxylated bisphenol A dimethacrylate (e.g., CD540, CD542, SR101, SR150, SR348, SR480 or SR541 from Sartomer), and urethane diacrylate (e.g., CN959, CN961, CN964, CN965, CN980 or CN981 from Sartomer; Ebecryl 230, Ebecryl 270, Ebecryl 8402, Ebecryl 8804, Ebecryl 8807 or Ebecryl 8808 from Cytec). Suitable photoinitiators may include, but are not limited to, bis-acyl-phosphine oxide, 2-benzyl-2-(dimethylamino)-1-[4-(4-morpholinyl)phenyl]-1-butanone, 2,4,6-trimethylbenzoyl diphenyl phosphine oxide, 2-isopropyl-9H-thioxanthen-9-one, 4-benzoyl-4′-methyldiphenylsulphide and 1-hydroxy-cyclohexyl-phenyl-ketone, 2-hydroxy-2-methyl-1-phenyl-propan-1-one, 1-[4-(2-hydroxyethoxy)-phenyl]-2-hydroxy-2-methyl-1-propane-1-one, 2,2-dimethoxy-1,2-diphenylethan-1-one or 2-methyl-1[4-(methylthio)phenyl]-2-morpholinopropan-1-one. Suitable mold release agents may include, but are not limited to, organomodified silicone copolymers such as silicone acrylates (e.g., Ebercryl 1360 or Ebercryl 350 from Cytec), silicone polyethers (e.g., Silwet 7200, Silwet 7210, Silwet 7220, Silwet 7230, Silwet 7500, Silwet 7600 or Silwet 7607 from Momentive). The composition may further optionally comprise one or more of the following components, a co-initiator, monofunctional UV curable component, multifunctional UV curable component or stabilizer.

The contents of all of the patents and patent application referred to above are incorporated herein by reference in their entirety.

The color tuning agent may be added, and homogeneously or heterogeneously distributed, into the composition for forming the display cell structure and/or the primer layer. In one embodiment, the color tuning agent may be self-dispersible. Alternatively, a dispersant, such as Triton X-100 (polyethylene glycol p-(1,1,3,3-tetramethylbutyl)-phenyl ether) or BYK163 (wetting and dispersing additive for solvent-borne coatings), may be added to promote dispersion of the color tuning agent in the composition.

When a color tuning agent is present in the display cell structure and/or a primer layer, the agent may absorb the visible light. Alternatively, in the case of a leuco dye, which does not significantly absorb the visible light, the color tuning may be achieved by radiation applied later on. The leuco dyes are most favorable for this aspect of the present invention because radiation would change the absorption spectrum of the leuco dye.

For example, during the embossing step for forming display cells, the leuco dye will not shield the UV radiation necessary for hardening of the composition for the display cell structure and/or the primer layer. However, after the display cell structure and/or primer layer is formed, two or more colors may be achieved with the composition containing the leuco dye, after exposure of the display structure to UV radiation. This radiation color changing can be set up to be combined with formation of the display cell structure and/or the primer layer, thus there is no extra processing cost and time needed.

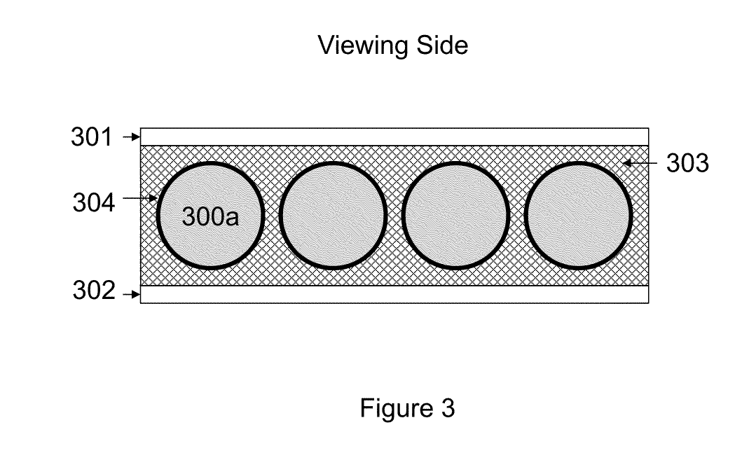

FIG. 3 illustrates how the present method may be applied to a microcapsule-based display device. In this case, the microcapsule walls (304) or any polymer matrix or adhesive material (303) surrounding the microcapsules may be formed from a composition comprising a color tuning agent, such as a leuco dye. The polymer matrix or adhesive material can be either on the same plane as the microcapsules or partially or fully on top of the microcapsules. In the latter case, the polymer matrix or adhesive material would be closer to the viewer.

It is possible to add a color tuning agent other than a leuco dye into a composition for forming a display cell structure. In one embodiment, the partition walls may be transparent and with the added color tuning agent, the images displayed would have an acceptable color temperature. In another embodiment, a color tuning agent may be added to a layer underneath the display cell structure and in this case, this layer may be seen through the transparent partition walls. It is also possible to add a color tuning agent into both the composition for forming the walls and the composition for forming the layer underneath the display cell structure.

The concentration of the color tuning agent in any of the compositions described above may be less than 3% by weight.

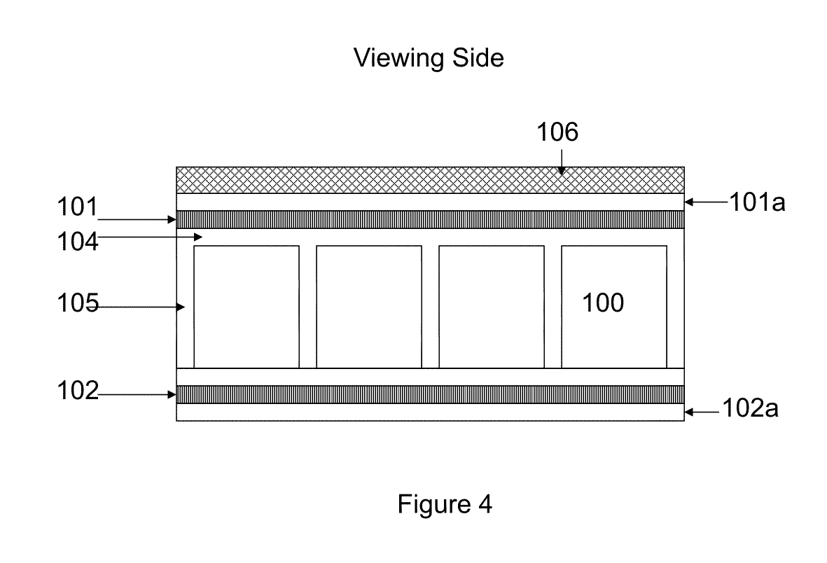

In another aspect of the present invention, a separate layer formed from a color tuning composition is shown in FIG. 4. The color tuning layer (106) is formed on a substrate layer (101a) opposite of the electrode layer (101).

Although not shown, the color tuning layer may also be coated on a substrate layer of a functional layer in a display device. In this embodiment, one side of the substrate layer is the color tuning layer whereas the other side of substrate layer is the functional layer. The functional layer may be an antiglare film, a luminance enhancement structure, a gas barrier layer or the like.

After a color tuning composition is coated on a substrate layer, the composition may be hardened by drying, radiation or both.

The color tuning composition referred to in this aspect of the invention may comprise a polymer carrier and a color tuning agent. The polymer carrier is used to hold the color tuning agent in a solid form. Suitable polymer carriers may include, but are not limited to, thermoplastic materials, thermoset materials, or precursors and derivatives thereof, such as polyvinyl acetate, polyacrylate, polyurethane, polyvinyl butyral, polyvinyl chloride, polyester, polyacrylic or any other UV curable materials.

Solvents are used to dissolve or disperse the polymer carrier and color tuning agent to form the color tuning composition. The composition in a liquid form may then be coated onto a substrate layer, using traditional coating methods. The solvent used is usually an organic solvent, such as one selected from the group consisting of ketones, alcohols, tetrahydrofuran, toluene, xylene, dimethylformamide, diethylene glycol, dimethyl sulfoxide, acetonitrile hexane, cyclohexane and the like. An aqueous solvent may also be used.

It is preferred that the weight percentage of the polymer carrier in the composition is less than about 60%, more preferably about 5% to about 30%, and the weight percentage of the color tuning agent is preferably less than about 3%, more preferably about 0.1% to about 1%. The remaining is solvent and additives.

For most of organic color tuning agents, especially dyes or organic fluorescent materials, the composition can be prepared by simply dissolving all the solid components in a solvent or a mixture of solvents and mixing well with proper agitation. If pigments or phosphors are used, dispersing tools, such as a milling machine, homogenizer or sonicator, are required to disperse the solid materials into the liquid polymer solution. Commonly used dispersing agents, such as Triton 100 (polyethylene glycol p-(1,1,3,3-tetramethylbutyl)-phenyl ether) or BYK163 (wetting and dispersing additive for solvent-borne coatings), may be added to facilitate dispersion of pigments or phophors.

Alternatively, the color tuning agent in a color tuning composition may be directly incorporated into a functional layer in a display device. For example, the color tuning agent may be dispersed in a composition for forming an adhesive layer, antiglare coating or hard coating.

In the case of an adhesive layer, the adhesive material itself can be a liquid or solid adhesive, such as rubber, styrene butadiene copolymer, acrylonitrile butadiene, polyisobutylene, silicone elastomer, polyvinyl acetal, polyvinyl acetate, polyvinyl alcohol, ethylene vinyl acetate copolymer, cellulosic resin, polyamide, polyester, polyurethane, polyolefins, polysulfone, phenoxy, acrylic, a UV curable material or the like.

In the case of hard coating or antiglare coating, a color tuning agent may be added to a thermoset polymer that can be thermally or UV cured. Suitable thermoset polymers include, but are not limited to, acrylate, polyurethane-acrylate, epoxy-acrylate, epoxy, organic silicone and two component polyurethane.

Further alternatively, the color tuning agent may be embedded in a composition for forming a plastic substrate or in a composition for forming a luminance enhancement structure, to achieve the same desired results. Details of luminance enhancement structure are given in U.S. Pat. Nos. 7,830,592, 8,237,892, 8,456,589; US Publication Nos. US2009-0231245, US2010-0141573, US2010-0177396, US2010-0182351,US2010-0225999, US2010-0271407 and U.S. application Ser. No. 12/837,350, the contents of all of which are incorporated herein by reference in their entirety.

For plastic substrates, the color tuning agents need to be mixed with the plastic polymer component before extrusion of the plastic film or the color tuning agents can be added in at a high temperature. When the color tuning agent is added into a composition, such as luminance enhancement structure or a functional layer, the color tuning agent is dissolved or dispersed in the composition.

A leuco dye may also be added into a separate color tuning layer and upon irradiation, the color tuning layer would have a desired color to adjust the color temperature of the colors displayed by a display device.

In any of the aspects of the present invention described, an additional color protection layer may be added to a display device to prevent the active radiation absorption by the color tuning agent to further change its color, so that the tuned color is maintained. The color protection layer may be combined with other functional layers on top of a display device. For example, a color protection layer may be a layer comprising a UV blocker. An adhesive layer may sit on top of a display device, either for protection film lamination or for touch panel integration.

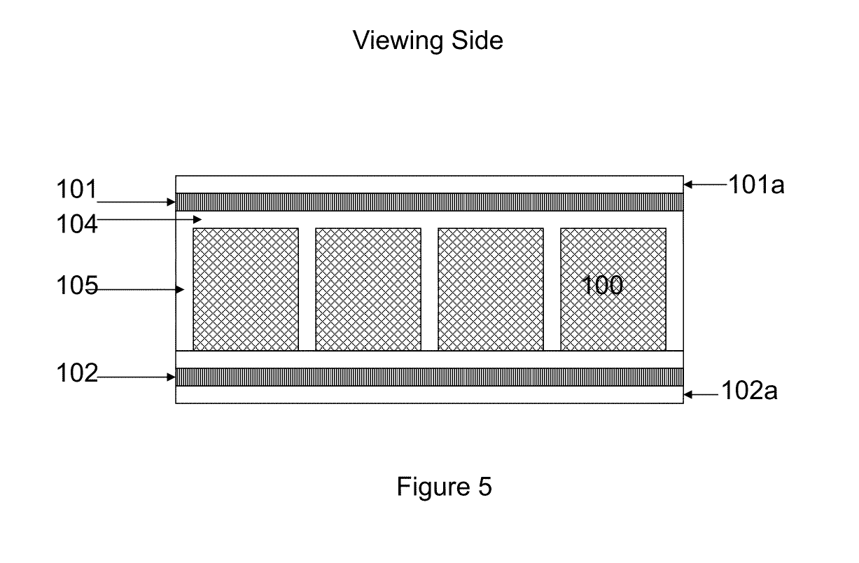

In a further aspect of the present invention, a small amount of a color tuning agent may be added to an electrophoretic fluid to solve the tinting issue (see FIG. 5). For example, the concentration of the color tuning agent may be in the range of 0.1 to 3% by weight, preferably, 0.5 to 2% or 0.5 to 2% by weight.

The fluid may comprise one type of charged pigment particles, two types of oppositely charged pigment particles or multiple types of charged pigment particles. The charged pigment particles can display their individual color state.

A color tuning agent, which may be in the form of particles, carries the same charge polarity as one type of the charged pigment particles, usually the white charged particles, to allow them to move along with the white particles in an electric field. As a result, the color tuning agent can adjust the color temperature of the white color state.

There are other means to allow the color tuning agent to move along with charged pigment particles. For example, the color tuning agent may be uncharged, but can be absorbed onto the surface of the charged pigment particles (e.g., white).

The selection of color tuning agents depends on the existing color issue.

The materials for color tuning agent used in an electrophoretic fluid are either organic or inorganic pigments. Generally organic pigments show a higher coloring strength and are more efficient to achieve the effect with smaller quantities. Suitable organic pigments include CI pigment PB15:1, PB15:2, PB15:3, PG36, PG58, PG7, PY138, PY150, PY20, PY83, and the like, which are commonly used organic pigment materials described in the color index handbook “New Pigment Application Technology” (CMC Publishing Co, Ltd, 1986) and “Printing Ink Technology” (CMC Publishing Co, Ltd, 1984).

Specific examples of the color tuning agent may include Clariant Hostaperm Blue B2G, Blue B4G, Hostaperm Pink E-EDS, PV fast red D3G, Hostaperm red D3G 70, BASF Irgazine red L 3630, Cinquasia Red L 4100 HD, Irgazin Red L 3660 HD, Clariant Novoperm yellow HR-70-EDS, Green GNX, or the like. The color tuning pigment can be red, green, blue, cyan, magenta, yellow or any other color as desired.

As stated, the color tuning agent may be in the form of particles. The particle size may be 0.1 to 1.0 μm. In one embodiment, the raw pigment surface will be modified to make the particles dispersible in an electrophoretic fluid.

In one embodiment, the color tuning agent may be a blue pigment such as CI pigment PB 15, PB15:1, PB15:2, PB15:3 or PB15:4 to adjust the color temperature of a white color state. The concentration of the blue pigment color tuning agent may be in the range of 0.1 to 3% by weight, preferably in the range of 0.5 to 2% by weight. As stated above, the addition of a color tuning agent, in the context of the present invention, would only change the color temperature of a color displayed, especially the white color state. Because of the low concentration, the display device would not display the color of the color tuning agent.

In one embodiment, the color tuning agent may also be a green pigment such as PG36, PG58 or PG7 for adjusting the color temperature of the white color state. The concentrations indicated above for the blue pigment color tuning agent are applicable to these agents as well.

The color tuning agent may also be a dye, as those described in the present application. Dye can be either dissolved or dispersed in the fluid. Dye can also be chemically or physically bonded to charged particles so it can move along with them.

### EXAMPLES

### Example 1

### Color Tuning Layer as a Separate Coating

TABLE 1

| | | | % By |
|---|---|---|---|
| | | | Weight |
| | Chemical | % By | in Dry |
| Component | Name | Weight | Form |
| Polyacrylate | — | 32.42 | 99 |
| Resin | | | |
| Tinopal OB | 2,5-Thiophenediyl- | 0.16 | 0.5 |
| | bis(5-tert-butyl-1,3- | | |
| | benzoxazole) | | |
| UV | Bis(1,2,2,6,6- | 0.16 | 0.5 |
| Stabilizer | pentamethyl-4- | | |
| 292 | piperidinyl) | | |
| | sebacate | | |
| Tetrahydrofuran | — | 67.26 | — |

Tinopal OB and UV stabilizer 292 were first dissolved in tetrahydrofuran and then a polyacrylate binder, the polyacrylate resin Elvacite 2028, was added in the solution with agitation. The mixture was kept under stirring until the polymer binder was completely dissolved. The resulting solution was coated on a PET plastic film surface with a wire wound coating rod (#6) and dried in an oven for 1 minute at 100° C. The resulting film had a thickness of about 5 um, and emitted blue visible light when exposed to UV light with a wavelength around 370 nm. This color tuning layer was laminated to an electrophoretic display film.

In Table 2 below, colors are expressed as the a* and b* values in the CIE L*,a*,b* color space system.

It is clear from the table that b* value of a color displayed (i.e., white) had been tuned from 1.14 to −1.59 when the color tuning layer was present. If a thicker color tuning layer is used (˜20 um), the reflectance of the display film would also be increased by about 2%.

TABLE 2

| | Without Color Tuning | With Color Tuning |
|---|---|---|
| | Layer | Layer |
| a* | −2.43 | −1.92 |
| b* | +1.14 | −1.59 |

### Example 2

### Color Tuning Material Incorporated into an Adhesive

TABLE 3

| | % By | % By Weight in Dry |
|---|---|---|
| Component | Weight | Form |
| Thermoplastic | 11.3 | 99.8 |
| Polyurethane | | |
| Pigment Red | 0.023 | 0.2 |
| Methylethyl | 88.677 | — |
| Ketone (MEK) | | |

Red pigment particles were first dispersed in MEK with a mill roller for 24 hours and then homogenized for 10 minutes. Polyurethane resins were then added into the solution and stirred until they were completely dissolved. The mixture was coated onto a release liner with a drawdown bar at a thickness of 3 mil and then dried in an oven at 100° C. for 2 minutes. A luminance enhancement structure was laminated onto a display film with the resulting adhesive composition through the use of a laminator at 120° C. and 80psi. The presence of the color tuning adhesive layer caused a shift of the a* value in the CIE L*,a*,b* color space system of the white color to the positive direction by 1 unit and neutralized the green tint.

### Example 3

### Color Tuning in an Electrophoretic Fluid

About 1% by weight of a blue color tuning agent (Clariant Hostaperm B2G), was added to an electrophoretic fluid which comprised oppositely charged black and white particles. The fluid had about 4% by weight of the positively charged black particles and about 27% by weight of the negatively charged white particles. The blue color tuning agent was also negatively charged.

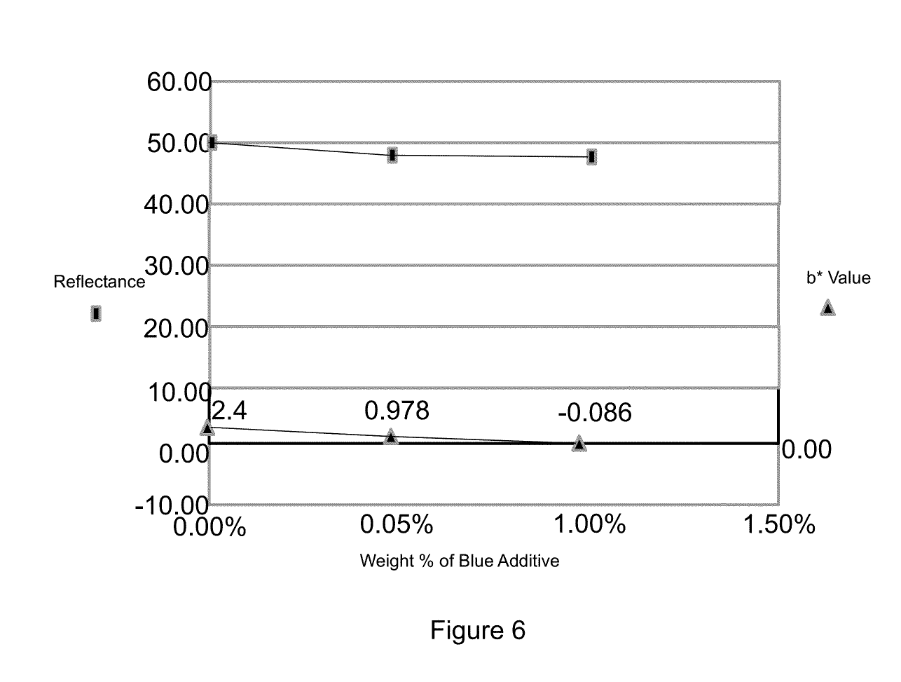

As shown in FIG. 6, originally a display film showed a yellowish tint and had a b* value higher than 2 at the white state, a blue pigment therefore was selected as a color tuning agent to decrease the b* value to 0 for a neutral white state. When the blue color tuning agent (Clariant Hostapern blue B2G) concentration in fluid reached 1% by weight, the b* value further decreases to −0.086, signifying that the yellow tint at the white state had been neutralized.

Another aspect of the present invention is directed to a method for adjusting the color temperature of an electrophoretic display.

In the method, the color spectra of an electrophoretic display are first obtained. A UV-vis spectrometer can be used to obtain the absorption spectra of the display device; while colorimeters can be used to determine the reflectance of the device.

In addition to the spectra, a CIE L*,a*,b* color space system may also be used to determine the color temperature of a display device.

Following the method of the present invention, the a* value in the CIE L*,a*,b* color space system may be achieved between 3 and minus 6 (i.e., −6), preferably between 0 and minus 3 (i.e., −3), more preferably between 0 and minus 1.5 (i.e., −1.5) and the b* value may be achieved between 4 and minus 5 (i.e., −5), preferably between 1 and minus 2 (i.e., −2), more preferably between 0 and minus 2 (i.e., −2). In one embodiment, the ranges indicated above refer to a white color state.

Based on the spectra obtained, a color tuning agent is then selected to adjust the color temperature, if needed.

While the present invention has been described with reference to the specific embodiments thereof, it should be understood by those skilled in the art that various changes may be made and equivalents may be substituted without departing from the scope of the invention. In addition, many modifications may be made to adapt a particular situation, materials, compositions, processes, process step or steps, to the objective, spirit and scope of the present invention. All such modifications are intended to be within the scope of the claims appended hereto.

What is claimed is:

1. A method for adjusting color temperature displayed by a display device comprising an electrophoretic fluid, wherein the electrophoretic fluid comprises charged pigment particles dispersed in a solvent in which one type of the charged pigment particles is of the white color and the white charged pigment particles are capable of displaying a white color state,
the method comprises adding 0.1 to 3% by weight of a color tuning agent into the electrophoretic fluid, wherein the color tuning agent carries the same charge polarity as the white charged pigment particles.

2. The method of claim 1, wherein adjustment of the color temperature of the white color state is defined by the change of a* or b* in the L*,a*,b* color space system being less than 5.

3. The method of claim 1, wherein the color tuning agent is selected from the group consisting of CI pigment PB15:1, PB15:2, PB15:3, PG36, PG58, PG7, PY138, PY150, PY20, and PY83.

4. The method of claim 1, wherein the concentration of the color tuning agent is 0.5 to 2% by weight in the fluid.

5. The method of claim 1, wherein the color tuning agent is in the form of particles.

6. The method of claim 1, wherein the color tuning agent is a blue pigment.

7. The method of claim 5, wherein the blue pigment has a concentration of 0.1 to 2% by weight in the fluid.

8. The method of claim 6, wherein the blue pigment has a concentration of 0.5 to 2% by weight in the fluid.

9. The method of claim 1, wherein the color tuning agent is a green pigment.

10. The method of claim 8, wherein the green pigment has a concentration of 0.1 to 2% by weight in the fluid.

11. The method of claim 9, wherein the green pigment has a concentration of 0.5 to 2% by weight in the fluid.

12. The method of claim 1, wherein the color of the color tuning agent is not displayed.

13. The method of claim 2, wherein the color tuning agent causes a* to be between 3 and minus 6.

13. The method of claim 2, wherein the color tuning agent causes a* to be between 0 and minus 3.

14. The method of claim 2, wherein the color tuning agent causes a* to be between 0 and minus 1.5.

15. The method of claim 2, wherein the color tuning agent causes b* to be between 4 and minus 5.

16. The method of claim 2, wherein the color tuning agent causes b* to be between 1 and minus 2.

17. The method of claim 2, wherein the color tuning agent causes b* to be between 0 and minus 2.
